(19) United States
(12) Patent Application Publication
(10) Pub. No.: US 2008/0110042 A1
(43) Pub. Date: May 15, 2008

(54) Tumble-Dryer

(75) Inventors: Uwe Ackermann, Schönwalde-Glien (DE); Lothar Dittmer, Berlin (DE); Uwe-Jens Krausch, Brieselang (DE); Harald Moschutz, Grossbeeren (DE); Kai Nitschmann, Neuenhagen (DE); Ingo Schulze, Rontgental/Zepernick (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH ü, Münich (DE)

(21) Appl. No.: 11/665,507

(22) PCT Filed: Oct. 18, 2005
(86) PCT No.: PCT/EP05/55327

§ 371 Date: Apr. 13, 2007

(30) Foreign Application Priority Data
Nov. 19, 2004 (DE) 10 2004 055 942.2

(51) Int. Cl. F26B 3/02; F26B 11/02; F26B 11/00

(52) U.S. Cl. 34/487; 34/140; 34/130

(57) ABSTRACT

A method and a device for drying wet washing that has been placed in a drier device equipped with a rotatable drum. The stream of drying air is guided in such a way that the surface of the washing to be dried that is exposed to said stream is maximised. To achieve this, the invention provides a washing spacer, at least some sections of which are flexible and on which the washing to be dried can be placed. The spacer can then be rolled up together with the washing to be dried into a preferably cylindrical form. The washing spacer and the wet washing, which is rolled with a radial distance between its layers, is connected in an air-conductive, sealed manner to the extraction opening, allowing the stream of drying air to be guided through the washing spacer and the washing to be dried. Said method is extremely effective and reduces the drying times.

The invention relates to a method for drying items of washing and clothing that have been placed stationarily in a dryer with a rotatable drum, and devices for realising the method.

The invention relates to a drying device which can optionally be installed in a tumble-dryer with a rotatable drum, as an additional component, and can be secured in such a manner that the washing to be dried and placed on or in the drying rack remains stationary in any operating condition of the tumble-dryer. Tumble-dryers of the type in question have a filling opening for loading and unloading the tumble-dryer, a door for sealing the filling opening, a fan, ducts and conducting devices for conducting the process air in a closed circuit and a heating system for heating the process air. The heated drying air stream is guided through an admission opening in the rear drum wall into the interior of the drum, where the drying air stream is enriched with moisture from the washing to be dried. The moist drying air stream is sucked out through an extracted air opening in the region of the dryer door and is fed via a lint screen to the condenser. There the extracted air is cooled and the absorbed moisture is condensed. The condensed water is guided into a storage container or is discharged to the surrounding area. After the extracted air has passed through the condenser the air stream is in turn guided from the fan to the heating device and is there heated to the desired drying temperature.

With the methods and devices in question dryers with a rotating drum are also used for drying items of washing and clothing which must not be moved during the drying process, to prevent the washing to be dried, such as knitted products or woollen items of clothing, from shrinking or to prevent other damage to the washing to be dried. The washing to be dried is placed stationarily in additional devices specially designed for this purpose and is arranged so that contact between the washing to be dried and the rotating drum is prevented and the washing to be dried cannot be damaged. To achieve a desired drying result within acceptable drying times when washing to be dried is placed stationarily in the dryer, the washing should, if possible, be arranged in a single layer in the dryer. This applies particularly to woollen items of clothing since the drying process lasts an extremely long time in the case of such items if there is no wick effect.

The patent publication U.S. Pat. No. 4,908,959 discloses a drying rack which is provided for the stationary placing of washing to be dried in a drum of a tumble-dryer. The drying rack is fastened in the door region of the tumble-dryer and is retained there so that it is prevented from twisting. The washing to be dried lies on a horizontal grill supported on a pan underneath. The pan is connected at the front to the extraction opening and therefore serves as a device for guiding the draying air stream. The drying air stream hits the horizontal washing to be dried from above and is sucked out from underneath the washing to be dried through an extracted air duct.

In the case of this rack and dryer air guide system the efficiency of the drying process depends on how uniformly distributed the washing to be dried is placed on the grill. An optimum drying result can only be achieved when the entire surface of the drying grill is covered with washing to be dried and lies on it completely uniformly, preferably in one layer. Such conditions are hardly realisable in the practical use of the device. A further major disadvantage lies in the fact that the available drying surface is relatively small.

Another device for the stationary placing of washing to be dried in a drum of a tumble-dryer is disclosed in DE 101 03 986 A1. The device consists of a drying rack which is secured by means of fastening straps to the bearing plate of the tumble-dryer and is retained on so that cannot twist, as well as an inner rack that can be inserted in the drying rack, which inner rack can be inserted in an outer fixedly arranged cover and is constructed with several levels. The washing to be dried can be placed so that they are distributed on layers lying one above the other and hence spaced in relation to each other. The surface of the washing to be dried in the tumble-dryer that can be loaded with the drying air stream may therefore be considerably enlarged and it is possible to shorten the time until a desired degree of drying is reached quite significantly.

The user is obliged to ensure that the items of clothing to be dried are arranged in a manner that favours the drying process. The operations required for this are relatively expensive and inconvenient to carry out.

What is much simpler to handle is a roll-up washing spacer of prior art in which overlapping regions of the washing to be dried are kept stationarily relative to each other. In the simplest case the washing spacer consists of a rectangular mat of a flexible, air- and moisture-permeable material. In another design the roll-up spacer consists of several segments which are articulated to each other and which can be pivoted against axially against each other in such a manner that the spacer can be rolled up together with the washing to be dried, placed in the dryer, into an at least approximately spiral-shaped form.

The washing spacer is retained stationarily in the drum by a rack or a drying basket which is suspended in the region of the dryer door in retaining devices provided for this purpose, or is fastened by any other method so that it is prevented from twisting.

The drying air stream is able to flow through the washing spacer so that the washing to be dried can be loaded between the spacer and the drying air stream.

The washing to be dried is placed by the user on the washing spacer spread out flat and is rolled up with it into a spiral-spaced form, the washing to be dried being fixed and fully enclosed between the individual layers. Besides simple handling, such a washing spacer has the advantage of being able to accommodate a large quantity of washing to be dried, according to the thickness of the washing spacer.

A common disadvantage of the solutions previously described is that the drying air stream is not conducted to the optimum degree, the drying process therefore lasts too long and the expenditure of energy required is disproportionately high.

The object of this invention is therefore to make available a method for efficient drying of washing to be dried placed stationarily in a dryer with a rotating drum, as well as to indicate devices for realising the method which are easily to integrate into devices of prior art and can be adapted at low cost to different dryer embodiments. A particular object of the invention is to conduct the drying air stream and arrange the washing spacer with the washing to be dried in such a manner that the drying process takes place as efficiently as possible.

According to the invention this object is achieved with a method for guiding the drying air according to the features of claim 1 and with devices for implementing the method according to the features of claim 4.

Further features and advantages are contained in the following dependent claims. According to the invention the drying air stream is limited essentially to the region which is formed by the items of washing or clothing and the devices intended for their support. Here it is advantageous to guide the drying air stream in a forced fashion, by suitable means, through this region, preferably in an axial direction of the drum.

As a result of this process the loading of the washing to be dried with hot air is intensified, which shortens the drying process and increases its efficiency.

To implement the method according to the invention use is made of the roll-up, air- and moisture-permeable washing spacer of prior art described above. Provision is made, in particular, for the interface between the washing spacer and the extraction opening to be designed so that they match each other in such a manner that forced guidance of the drying air can be assured without expensive additional devices. The solution according to the invention provides for the matching the air extraction opening and the air-permeable washing spacer to each other, in terms of design, so that an almost airtight connection can be made between the washing spacer and the extraction opening. The drying air stream is therefore guided in forced fashion through the washing spacer with the washing to be dried, which is kept spaced out inside the spacer, and the loading of the wet washing to be dried with drying air is intensified.

A tight connection according to the invention between the washing spacer and the extraction opening can be established simply by connecting the washing spacer and the extraction opening by means of a clamping seal or sealing collar which acts on the surface area of the spacer or bears against it.

In an advantageous design the admission opening of the extraction duct is formed by a flat disc with a multiplicity of air penetration openings. The end face of the washing spacer, which is also flat, bears flush, or exclusively with the outer edge, in a sealed manner against the flat disc, supported by pressure. The sealing action can be improved by a sealing ring which is fitted on the flat disc surrounding the air penetration openings.

A preferred design variant of the invention provides for the integration in the air guidance means in the retaining device for the washing spacer. Such a device is preferably designed in two parts with a moving part which is designed as a means for fixing the retaining device, and at the same time as an air guidance device.

In order to improve the sealing connections described, provision is made in a further advantageous design of the invention, for the end face of the rolled up washing spacer to be almost constant independently of the items of washing received in the washing spacer and of shape and size. This may be achieved in that the washing spacer is manufactured from a thickness elastic material or in that simple means are installed in the edge region of the washing spacer for the fixed spacing of the washing to be dried in the rolled up washing spacer.

The guidance of the drying air stream may be advantageously optimised by designing the surface area of the washing spacer so that it is impermeable to air. This necessarily directs the axial stream of the drying air through the washing spacer.

Further designs and advantages of the invention are evident from the following description of the exemplary embodiments. In these embodiments provision is made, in particular, for the interface between the washing spacer and the extraction opening to be designed so that they are matched to each other in such a manner that force guidance of the drying air can be guaranteed without expensive additional devices.

Further advantageous designs may be deduced from the descriptions of the exemplary embodiments, which are explained in the following with reference to the drawings, in which:

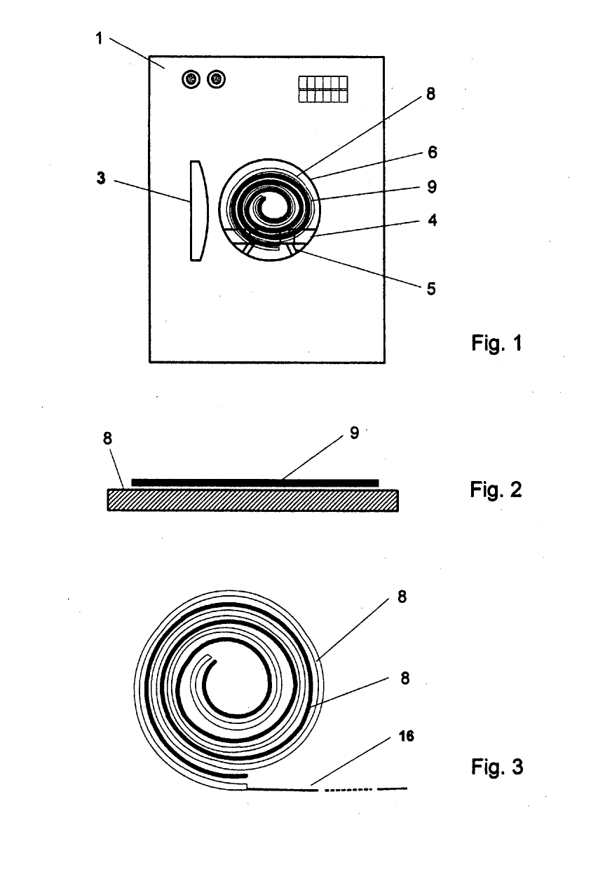

FIG. 1 shows a schematised front view of a drying device with a washing spacer arranged therein;

FIG. 2 shows a washing spacer with washing to be dried placed therein in a flat condition;

FIG. 3 shows a washing spacer with washing to be dried in a rolled-up condition;

FIG. 4 shows a washing spacer with a plurality or rigidly designed segments articulated together,

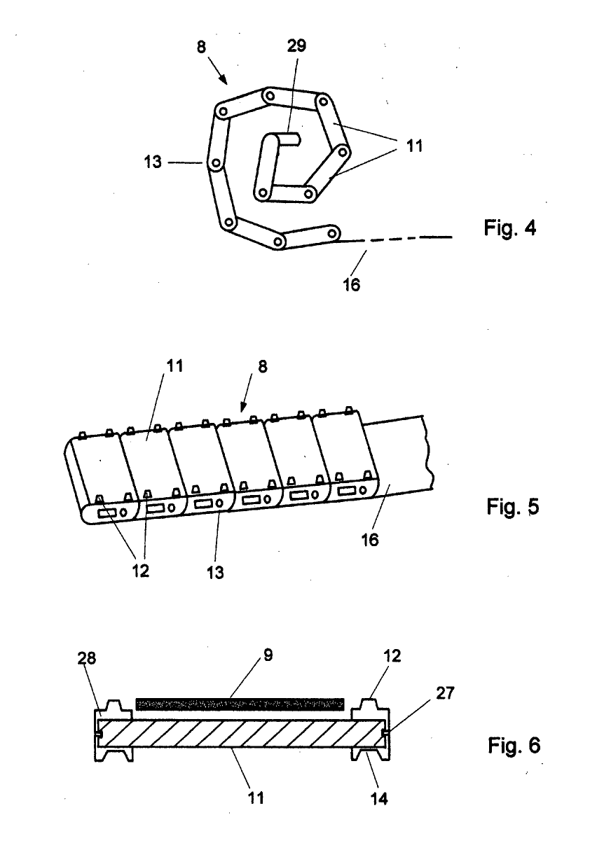

FIG. 5 shows a three-dimensional representation of the washing spacer of the device according to FIG. 4 in its flat condition,

FIG. 6 shows a sectional representation of the washing spacer of the device according to FIG. 5 with washing to be dryer placed in it and a spacer collar on the edge side,

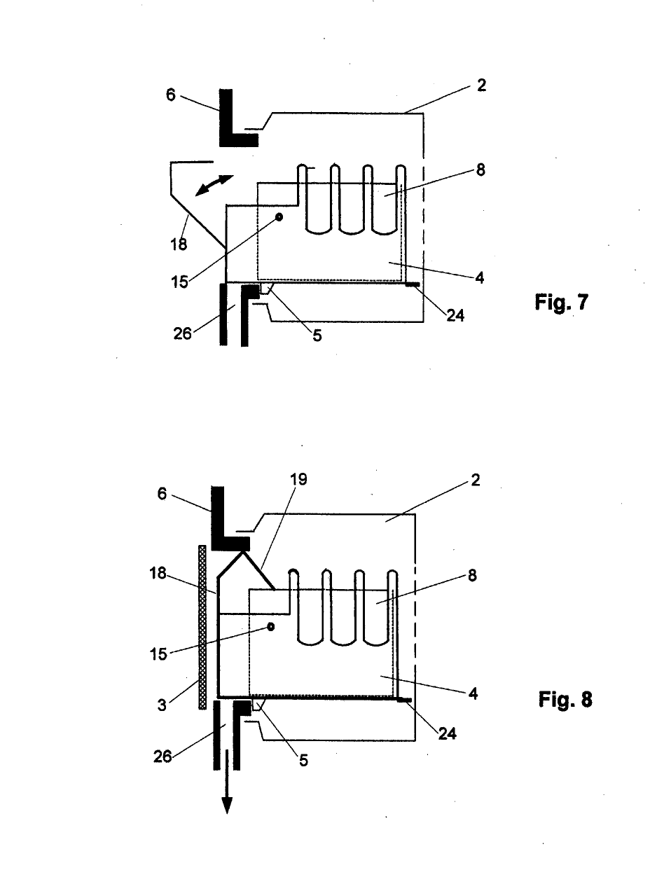

FIG. 7 shows a washing spacer with a retaining device during the insertion process (side view),

FIG. 8 shows a washing spacer with a retaining device in the installation position (side view),

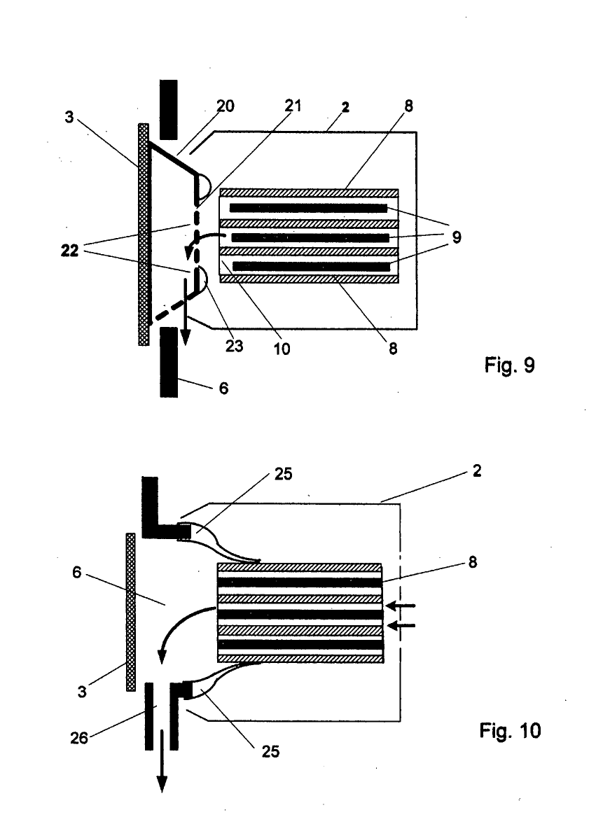

FIG. 9 shows a washing spacer with an end-face seal,

FIG. 10 shows a washing spacer with a jacket-side seal.

In the exemplary embodiments to be described in the following a device type is assumed such as that predominantly used. A characteristic of such a tumble-dryer is that the process air stream heated to a predetermined temperature is blown through the rear drum wall into the interior of the drum, where the heated air hits the washing to be dried. The feed opening incorporates an extraction opening through which the moist extracted air is first guided through a lint screen and is then fed to the condenser. The extracted air is cooled in the condenser and the moisture is removed from the extracted air. In the closed circuit the cooled air is fed back to the heating system.

FIG. 1 shows such a tumble-dryer 1 in the front view in a highly schematised representation in which all the functional parts not related directly to the invention have been omitted. Washing spacer 8 rolled up with at least one item of washing or clothing 9 is fixedly positioned in a retaining device 4, which is kept stable and torsionally resistant in the edge region of feed opening 6. The rolled up washing spacer 8 has the shape of a cylinder with an end face 10 is flat, at least in the outer edge region. FIG. 3 shows washing spacer 8 in a radial sectional representation. Washing 9 rolled up in one layer with washing spacer 8 is kept spaced and fully covered in this spacer. In comparison to this, the condition of washing spacer 8 is represented in FIG. 2 with washing 9 laid flat before rolling up.

Roll-up washing spacer 8 is produced wholly or partially from one or more air- and moisture-permeable materials, for example from a reticulated PUR foam, in which only the corner structures of the foam structure are maintained. The material of the roll-up washing spacer 8 is therefore also thickness elastic, which advantageously means that washing spacer 8 can always be rolled up by the user to almost the same size, thereby ensuring sufficient fitting accuracy for air extraction opening 26. Tolerances that are applicable are absorbed by means of the thickness elasticity.

Another form of washing spacer 8 is shown in FIGS. 4, 5 and 6. Washing spacer 8 is formed from a plurality of rigid segments 11, which are connected to each other by axial joints 13 or elastic strips and by means of which washing spacer 8 can be rolled up into at least an approximately cylindrical shape (FIG. 4).

FIGS. 5 and 6 show a washing spacer 8 with spacing knobs 12 standing at right angles and arranged in a row spaced along the two lateral edges. Corresponding to this, a through groove 14 are formed on the underside of washing spacer 8 each at the same distance to the two lateral edges, in which groove engage distance knobs 12 when washing spacer 8 is rolled up. Spacing knobs 12 and through grooves 14 are designed in the shape of a wedge. They can be formed integrally by suitable spacing of individual segments 11 of articulated washing spacer 8, or are part of strips of an elastic material, which are connected, for example, by gluing to washing spacer 8. FIG. 6 shows a collar 28 of an elastic material which positively surrounds the edge region of washing spacer 8 on the end face. Spacing knobs 12 and through grooves 14 form part of collar 28 and are advantageously moulded into it. The connection of collar 28 and washing spacer 8 can be improved by stop means 27 which engage on the end face in corresponding stop recesses of the segments of the washing spacer. Stop means 27 are also moulded into collar 28.

Collar 28 and the strips, which are elastic on both sides, with knobs 12 and grooves 14, are advantageously suitable as connecting element for segments 11 of washing spacer 8, and may therefore perform the function of articulated connectors 13.

Washing spacer 8, with spacing knobs 12 and through grooves 14, is very easy for the user to handle. When washing 9 to be dried is spread out on washing spacer 8, the lateral extension of the contact surface is limited by spacing knobs 12 and on the initial edge by a limiter 29. This almost excludes the possibility of parts of washing 9 to be dried projecting from the lateral edges of washing spacer 8. It also makes it easy for the user to roll up washing spacer 8 in a spiral-shaped form with flat end faces 10. Spacing knobs 12 and longitudinal grooves 14 act as guiding aids in this case, due particularly to their wedge shape. The user has no trouble either in correctly rolling up washing spacer 8 without paying special attention to it and therefore bringing it into the correct shape.

Rolled up washing spacer 8 with washing 9 to be dried, which kept spaced therein, has the shape of a cylinder with plane-parallel end faces 10. Spacing knobs 12 and through grooves 14, as well as limiter 29, ensure that the size and shape of the cylinder produced by the rolling up are always the same regardless of the amount and size of the received washing 9 to be dried, and end faces 10 of washing spacer 8 form a flat surface which are well suited as the contact surface for extraction opening 26.

To guarantee the dimensional stability of rolled up washing spacer 8, as shown in FIGS. 4 and 5, a textile web 16 is fixedly applied to the terminal edge of washing spacer 8, which web is coated with an air-permeable or almost air-permeable material and is approximately dimensioned so that washing spacer 8, when rolled up, can be enclosed once to one and a half times. Coated textile web 16 is provided with a Velcro zip or another suitable closing means so that rolled up washing spacer 8 can be kept dimensionally stable during the drying process.

The surface area of roll-up washing spacer 8 is air-impermeable or almost air-impermeable due to coated textile web 16 bearing against it. This forcedly directs the stream of drying air through washing spacer 8 and washing 9 to be dried and rolled up therein. Air-impermeable textile web 16 can be designed so that the surface area is fully covered or only partial areas are covered. However, for a favourable drying process it is advantageous to cover the jacket region facing air extraction opening 26 so that it is impermeable to air. Air-impermeable textile web 16 may also be used for washing spacers 8 of an elastic material.

In a very simple exemplary embodiment, shown in FIG. 10, the edge region of air extraction opening 26 is provided rotatably with a sealing collar 25 which, in the case of a washing spacer 8 inserted in dryer 1 and kept stable in retaining device 7, lies flat throughout its circumference. Sealing collar 25 is manufactured completely of an elastic material and is advantageously shaped so that it positively surrounds the edge region of feed opening 6. The flush contact of seal 25 causes the hot air stream blown into drum 2 to press against seal 25, thereby further reinforcing the sealing action.

Sealing collar 25 is very simple to use. It can be used with few operations, that are easy to carry out, and can be removed again. There is no problem at all in preserving collar 25 outside dryer 1 after use.

FIG. 9 shows a dryer 1 whose door 3 is designed as an extraction duct 26 and has an inwardly directed, pot-shaped washing deflector 20. Surface 21 of washing deflector 20, directed inside drum 2, is flat and provided with a multiplicity of air penetration openings 22. Washing spacer 8, fixedly positioned in retaining device 7, is approximately axial and is aligned in such a manner that the end face of washing spacer 8 and flat surface 21 of washing deflector 20 are parallel to each other. The shape and size of the end face of washing spacer 8 are adapted to flat surface 21 of washing deflector 20.

When dryer door 3 is sealed, flat surface 21 of washing deflector 20 is pressed in a sealed manner against the end face of washing spacer 8. In the case of a washing spacer 8 of elastic material this simple seal is entirely sufficient to guide the drying air stream forcedly through washing spacer 8 and washing 9 to be dried, kept suitably spaced therein. For a segmented washing spacer 8 of a flexurally resistant material, flat surface 21 of washing deflector 20 is advantageously provided with a sealing ring 23 enclosing air penetration openings 22 of washing deflector 20, against which ring bears washing spacer 8 with its outer edge.

The retaining devices for washing spacers 8 are not shown in the drawings of the two exemplary embodiments previously described. Such devices are known in a variety of different designs, e.g. as a suspended rack or basket. It is left to the discretion of the person skilled in the art to design a retaining rack or basket, adapted to a special type of dryer, so that washing spacer 8 can be positioned in drum 2 so that the flat end face of washing spacer 8 bears against surface 10 sealing extraction opening 26 in a sealed or almost sealed manner (example shown in FIG. 9), or a sealing connection to extraction opening 26 can be produced by the surface area of washing spacer 8 (example shown in FIG. 10).

In a preferred design variant of the invention the means for guiding the drying air stream form an integral part of retaining device 7 for washing spacer 8. The representations in FIGS. 7 and 8 show an exemplary embodiment of such a device during the insertion process and in the installation position. Lower section 17 of retaining device 7, in which washing spacer 8 is inserted and positioned, forms the actual retaining device together with upper section 18 pivotably articulated to lower section 17. Upper section 18 is angled at its end and receives, in the corner region, means, not shown in greater detail, for fixing retaining device 7. The fastening means engage in corresponding means in the door frame and therefore cause retaining device 7 to be stably connected to the door frame when upper section 18 is folded up. The edge region of the inwardly angled upper section 18 is designed so that it forms a semi-circle in the axial direction.

In the representation shown in FIG. 7 upper section 18 of retaining device 7 is swivelled downwards. In this condition the user inserts retaining device 7 into the interior of drum 1 and suspends it there. Retaining device 7 is supported at the bottom of the door frame by correspondingly designed means 5. This then swivels foldable upper section 18 upwards and hooks or engages it in the upper section of the door frame. Retaining device 7 is therefore fixed so that it is protected from twisting. Rolled up washing spacer 8, with textile 9 to be dried, is inserted in retaining device 7.

Foldable upper section 18, for retaining and locking support 7, is also the air guidance device. When upper section 18 is folded up into the stable position (FIG. 8), angled end section 19 of foldable upper section 18 is swivelled into drum interior 2, and forms with lower section 17 a circular air admission opening. Other designs of the air admission opening deviating from the circular shape are possible. It is essential for the opening formed when upper section 18 is folded up to be adapted in shape and size to washing spacer 8, or conversely, for washing spacer 8 to be shaped according to the shape and size of the support opening.

Retaining device 7 is advantageously adapted to the shape of feed opening 6 of each dryer 1. For each dryer 1 retaining device 7 and correspondingly washing spacer 8 may be constructed so that when the user easily handles the devices, washing spacer 8 displays an optimum receiving capacity.

The angled, semicircular air guidance device 19 presses against washing spacer 8 from above when upper section 18 is folded up. This condition is shown in FIG. 8. In the case of a washing spacer 8 of thickness elastic material, the pressure exerted is sufficient to establish an airtight connection between washing spacer 8 and the circular air admission opening.

In the case of washing spacers 8 of non-elastic material it is advantageous to provide air guidance device 19 and lower section 17 of retaining device 7 on the edges with a sealing collar which, in the operating condition, i.e. with upper section 18 folded up and hooked in, bears against the surface area of washing spacer 8.

The preferred retaining device 7 forms, with closed door 3, an air duct which guides the drying air from the individual layers of washing spacer 8 to air extraction opening 5 in the lower region of the door frame. Hot dry air flows through the air admission opening arranged at the rear in the drum wall, which dry air then preferably flow back into intermediate layers 8 of washing spacer 8, and there receives and discharges the moisture from the washing to be dried. The flow path of the process air aimed for, and forced by means of the inventive retaining device 7, is denoted in FIG. 8 by arrows.

In the preferred retaining device 7, the insertion and locking of device 7, and the insertion and removal of washing spacer 8, are very easy for the user to carry out. For further simplification of handling retaining device 7 when inserting it in drum 2, retaining device 7 is equipped with at least one spacer pin 24 on the side facing the drum base. This reduces the axial clearance of retaining device 7 in drum 2, which facilitates the positioning of the support and further reduces the possibilities of mishandling when inserting retaining device 7.

The integrated air guidance device 19 ensures that the drying air stream is forcedly guided through the inside of washing spacer 8 and washing 9 to be dried, which is spaced inside the spacer and is supported stationarily in it. The efficiency of the drying process is considerably increased and the drying time is substantially reduced by the inventive method implemented in that manner.

### REFERENCE NUMBERS

1. Tumble-dryer
2. Washing drum
3. Dryer door
4. Dryer insert, retaining rack, basket
5. Fastening means
6. Feed opening
7. Retaining device for washing spacer
8. Washing spacer
9. Washing to be dried, washing
10. End face of the washing spacer
11. Segments of the washing spacer
12. Spacing knobs
13. Articulated connection
14. Groove, longitudinal groove
15. Fulcrum
16. Coated textile web
17. Lower section of the retaining device
18. Pivotable upper section
19. Air guidance device
20. Washing deflector
21. Flat disc of the washing deflector
22. Openings in the washing deflector
23. Sealing ring
24. Spacer pin
25. Sealing collar
26. Air extraction opening, extraction opening
27. Stop means
28. Collar with spacing knobs
29. Limiter

1-32. (canceled)

33. A method for drying washing to be dried, which is placed stationarily in a rotatable drum, such as items of washing and clothing, wherein a drying air stream is limited essentially to the volume which is formed by the items of washing or clothing and by the devices for supporting them.

34. The method according to claim 33, wherein the drying air stream is forcedly guided.

35. The method according to claim 34, wherein the washing to be dried, placed stationarily in the rotatable drum, is loaded with the drying air essentially in one direction of flow in the axial direction of the drum.

36. A drying device for drying washing items to be dried comprising:
a rotatable drum receiving the washing items in a stationarily manner;
a feed opening providing access to the drum;
an air extraction duct and an air admission duct providing a drying air stream through the drum; and
a roll-up washing spacer being matched to each in terms of design so that a substantially almost airtight connection can be made between the washing spacer and at least one of the extraction opening and the air admission opening.

37. The drying device according to claim 36, wherein the feed opening includes an end region being provided in a rotatable manner with at least one of single and multi-layer sealing collar.

38. The drying device according to claim 37, wherein the sealing collar arranged in the end region of feed opening is removable.

39. The drying device according to claim 36, wherein the air extraction duct is sealed by a flat disc with a multiplicity of holes or slots, the flat disc being adapted as a contact surface for the washing spacer, in its shape and size, to an end face of the washing spacer.

40. The drying device according to claim 39, wherein the flat disc bears against the end face of the washing spacer when the door is closed.

41. The drying device according to claim 40, wherein the flat disc sealing the air extraction duct is provided with a sealing ring enclosing the holes or slots.

42. The drying device according to claim 36, further comprising a support for the washing spacer including a means for conducting and guiding the drying air stream.

43. The drying device according to claim 42, wherein the support for the washing spacer has at least one means for fixing the support, which is designed as a means for guiding the drying air stream.

44. The drying device according to claim 43, wherein the means for fixing the support has two or more parts with at least one part being a foldable upper section.

45. The drying device according to claim 42, wherein an edge region of the support is adapted to the size of the roll up washing spacer.

46. The drying device according to claim 44, wherein the support includes a lower section having means for positioning in the drum and means for receiving the washing spacer, and the foldable upper section for fixing the support is designed so that the support, when folded up, is stably connected to a wall of the feed opening.

47. The drying device according to claim 46, wherein the support, when folded up, forms on the inside an air admission opening whose edges bear in a sealed manner against the surface area of the washing spacer.

48. The drying device according to claim 46, wherein the edges of the lower section and of the upper section have an elastic seal.

49. The drying device according to claim 42, wherein the support has a spacer pin on the side facing the drum base.

50. The drying device according to claim 36, wherein the material of the roll-up washing spacer is air- and moisture-permeable.

51. The drying device according to claim 36, wherein the material of the roll-up washing spacer includes thick elastic.

52. The drying device according to claim 36, wherein at least a portion of the surface area of the rolled up washing spacer is substantially air-impermeable.

53. The device according to claim 36, wherein the roll-up washing spacer includes an end face being flat when the washing spacer is rolled up with at least one item of washing or clothing.

54. The drying device according to claim 53, wherein the end face of the roll-up washing spacer is always the same size and shape irrespective of the items of washing received in the washing spacer.

55. The drying device according to claim 54, wherein the washing spacer has vertical spacing knobs spaced along the two outer edges.

56. The drying device according to claim 55, wherein the vertical spacing knobs spaced along the two outer edges are molded into the segments of the washing spacer.

57. The drying device according to claim 55, wherein the vertical spacing knobs are part of a strip produced from elastic material, which strip is permanently connected to the washing spacer.

58. The drying device according to claim 55, wherein vertical spacing knobs, spaced along the two outer edges, are arranged on the upper side of the washing spacer, and, corresponding to this, a through groove runs on the underside of the washing spacer along each of the two outer edges, into which groove engages the spacing knobs when the washing spacer is rolled up.

59. The drying device according to claim 58, wherein the grooves are molded into the segments of the washing spacer.

60. The drying device according to claim 58, wherein the grooves are part of a strip produced from elastic material, the strip being permanently connected to the washing spacer.

61. The drying device according to claim 58, wherein the vertical spacing knobs and the grooves corresponding to them are part of a collar produced from elastic material, the collar enclosing the washing spacer on the end face on both lateral edges.

62. The drying device according to claim 61, wherein the elastic collar includes a stop means that engage on the end face and/or from above and below in corresponding stop recesses in the washing spacer.

63. The drying device according to claim 58, wherein the spacing knobs and the through grooves are designed in the shape of a wedge.

64. The drying device according to claims 57, wherein the segments of the washing spacer, produced from a flexurally resistant material, are connected by means of the collar or knob and groove strips glued to both sides.
